(19) United States
(12) Patent Application Publication
(10) Pub. No.: US 2025/0248400 A1
(43) Pub. Date: Aug. 7, 2025

(54) NANOPARTICULATE FORMULATION FOR PREVENTING OR TREATING CALLOSE FORMATION IN PLANTS

(71) Applicant: Purdue Research Foundation, West Lafayette, IN (US)

(72) Inventors: Kurt Ristroph, Lafayette, IN (US); Lucas Durand Johnson, West Lafayette, IN (US); Pablo Vega-Vasquez, West Lafayette, IN (US)

(73) Assignee: Purdue Research Foundation, West Lafayette, IN (US)

(21) Appl. No.: 19/045,905

(22) Filed: Feb. 5, 2025

Related U.S. Application Data
(60) Provisional application No. 63/550,164, filed on Feb. 6, 2024.

(51) Int. Cl. A01N 35/06; A01N 25/28; A01P 21/00

(52) U.S. Cl. CPC A01N 35/06; A01N 25/28; A01P 21/00

(57) ABSTRACT

A nanoparticulate formulation, which formulation comprises (i) a core comprising at least one antioxidant alone or further in combination with (a) at least one imaging agent, (b) at least one active agent, or (c) a combination of (a) and (b); and (ii) a shell comprising a stabilizer selected from an amphiphilic molecule, at least one block copolymer, and any combinations thereof; and methods of use for preventing or treating a callose formation and preventing or suppressing a hypersensitive response in plants.

### CROSS REFERENCE TO RELATED APPLICATION

This application claims priority to U.S. provisional patent application No. 63/550,164, which was filed Feb. 6, 2024, and which is hereby incorporated by reference in its entirety.

### TECHNICAL FIELD

The present disclosure relates to a nanoparticulate formulation comprising an antioxidant, its method of preparation, and its use for preventing, suppressing, and treating callose formation and hypersensitive response (HR) in plants.

### BACKGROUND

This section introduces aspects that may help facilitate a better understanding of the disclosure. Accordingly, these statements are to be read in this light and are not to be construed as admissions about what is or is not prior art.

Plants can react to disease or stress by forming calloses. Callose formation can be detrimental to plants as it can partially block plant vasculature or occlude plant tissue, which can lead to nutrient deficiencies and a decrease in overall plant health. In plant-pathogen interactions, the hypersensitive response (HR) is a defense mechanism employed by plants to recognize and restrict the spread of pathogens. It is an active immune response that involves a series of coordinated events aimed at limiting the damage caused by the invading pathogens.

The HR is triggered by the recognition of specific molecules associated with the pathogen, known as pathogen-associated molecular patterns (PAMP), or by the recognition of effector molecules secreted by the pathogen (ETI). One of the key features of the HR is the induction of localized cell death at the site of pathogen invasion.

During the HR, the formation of callose deposits is a crucial event. Callose is a complex polysaccharide that reinforces cell walls and seals off damaged areas. The formation of callose is mediated by the activation of various defense-signaling pathways during the HR. These signaling pathways trigger the production of enzymes called callose synthases. The callose deposition reinforces the cell walls, strengthens the structural integrity of the plant tissues, and prevents pathogens from entering the adjacent cells. In some instances, the HR can be counterproductive and detrimental to the overall health of the plant. For example, in the case of phloem-restricted pathogens such as certain viruses and bacteria, pathogens specifically target and infect the phloem tissue, which is responsible for nutrient transport throughout the plant. In the case of phloem-restricted pathogen invasion, the HR response can lead to the formation of calloses within the lumen of the phloem conduits. These calloses accumulate and form obstructions within the phloem, inhibiting the normal flow of nutrients from the source tissues to the sink tissues. The formation of calloses in the phloem lumen occurs as a part of the defense response, attempting to block the movement of pathogens through the vascular system. However, in the process, it also obstructs the vascular conduits and disrupts nutrient translocation. Therefore, callose deposits act as a physical barrier that impedes the flow of nutrients, leading to plant malnutrition. Plant malnutrition resulting from flowing obstruction can manifest in various ways. The affected plant may exhibit symptoms such as stunted growth, yellowing or chlorosis of leaves, reduced fruit development, and overall weakened vigor.

Without the proper distribution of nutrients, the plant's ability to carry out essential physiological processes, such as photosynthesis and metabolism, is compromised. Ultimately, the plant's overall health and productivity are negatively impacted. The HR involves the activation of several defense mechanisms, including the generation of reactive oxygen species (ROS) as part of the oxidative burst. When the oxidative burst is prevented, interrupted, or suppressed, it leads to a reduction in the intensity of the HR.

Currently, no treatments are available to alleviate, prevent, or cure callose formation. In the case of callose formation caused by pathogens infecting phloem or root in tree crops, such as citrus greening disease, the current approach involves injecting antibiotics into the tree trunk. However, this method is not effective for disease prevention or mitigation. Instead, it is primarily used as a last-resort effort to rescue severely infected trees by reducing the pathogen load in the plant's vascular system.

Therefore, there is an unmet need for a formulation that can prevent or treat callose formation in plants by modulating the immune response of plants and preventing or suppressing the HR. It is an object of the present disclosure to provide such a formulation. This and other objects and advantages, as well as inventive features, will be apparent from the detailed description provided herein.

### SUMMARY

Provided is a method of preventing or treating a callose formation in a plant, which method comprises administering to the plant an effective amount of a nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

In some embodiments, the nanoparticulate formulation is administered through foliar, root, trunk, or seed delivery.

The at least one antioxidant that can be used to prevent or treat callose formation in a plant is selected from astaxanthin, alpha-tocopherol, alpha-tocopherol acetate, beta carotene, lycopene, lutein, zeaxanthin, beta-cryptoxanthin, alpha-carotene, xanthophyll, retinol, retinal, canthaxanthin, violaxanthin, phytoene, phytofluene, neoxanthin, echinenone, resveratrol, pterostilbene, and a combination of two or more thereof.

The at least one antioxidant can be used alone or in combination with an imaging agent. The imaging agent can be selected from 1,1′-dioctadecyl-3,3,3′,3′-tetramethylindocarbocyanine perchlorate, hostasol yellow, hostasol red, perylene, vanadyl 2,9,16,23-tetraphenoxy-29H,31H-phthalocyanine, meso-tetraphenyl-tetrabenzoporphine palladium complex, a tracer metal and any combination thereof. The tracer metal can be selected from palladium, gadolinium, europium, vanadium, gold, and silver.

The at least one active agent can be selected from streptomycin, oxytetracycline, polymyxin b, colistin, gentamycin, vancomycin, mastoparan 7, tobramycin, kanamycin, amikacin, beta-cyfluthrin, zeta-cypermethrin, chlorantraniliprole, cyantraniliprole, propiconazole, propamocarb, prothioconazole, azoxystrobin, fludioxonil, benzovindiflupyr, boscalid, methoxyfenozide, sarmentine, spliceostatin C, spermine, spermidine, jasmonic acid, farnesene, squalene, diploptene, phytane, cycloartenol, stigmasterol, labdane, phytol, betulinic acid, abietane, cembrene A, cadinene, humulene, zingiberene, longifolene, caryophyllene, farnesol vetivazulene, guaiazulene, germacrene A, germacrene D, linalyl butyrate, copaene, geranyl butyrate, beta-Ocimene, P-cymene, patchoulol, geranyl propionate, viridiflorol, geranyl acetate, estragole, limonene, alpha-terpinyl acetate, thymol, carvacrol, beta-Pinene, neral, geraniol, citral, methyl eugenol, alpha-terpinene, linalool, perillic acid, perillaldehyde, methyl cinnamate, eucalyptol, eugenol, acetyleugenol, thujone, 4-carvomenthenol, camphor, guaianolide, cinnamaldehyde, bisacurone, rishitin, cyphenothrin, esfenvalerate, etofenprox, fenpropathrin, fenvalerate, flucythrinate, flumethrin, cyhalothrin, phenothrin, resmethrin, silafluofen, fluvalinate, and permethrin.

Any suitable amphiphilic molecule can be used as a stabilizer. In some embodiments, the amphiphilic molecule can be selected from hydroxypropylmethylcellulose acetate succinate (HPMCAS), lecithin (e.g., soybean lecithin), gelatin, zein, casein, tocopherol polyethylene glycol succinate, sucrose esters, sucrose alkyl esters, lauryl glucoside, decyl glucoside, octyl glucoside, alkyl glucosides, and any combination thereof. In some embodiments, the amphiphilic molecule is HPMCAS. In some embodiments, the amphiphilic molecule is a sucrose alkyl ester. In some embodiments, the sucrose alkyl ester is sucrose stearate or sucrose distearate.

Any suitable block copolymer can be used as a stabilizer. In some embodiments, the block copolymer comprises (a) at least one hydrophobic block selected from polycaprolactone, poly(lactic-co-glycolic acid), polystyrene, and polylactic acid; (b) at least one hydrophophilic block selected from polyethylene glycol, polyacrylic acid, and poly[2 (dimethylamino)ethyl methacrylate]; or (c) a combination of (a) and (b).

Provided is a method of preventing or suppressing a hypersensitive response in a plant, which method comprises administering to the plant an effective amount of a nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

In some embodiments, the nanoparticulate formulation is administered through foliar, root, trunk, or seed delivery. An antioxidant, an imaging agent, an active agent, an amphiphilic molecule, and a block copolymer that can be used in the formulation are as described above.

Further provided is a nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer comprises an amphiphilic molecule, wherein the core is encapsulated in the shell as a nanoparticle.

An antioxidant, an imaging agent, an active agent, and an amphiphilic molecule that can be used in the formulation are as described above.

In some embodiments, the nanoparticle is about 20 nm to about 300 nm in diameter.

### BRIEF DESCRIPTION OF DRAWINGS

FIG. 1A shows a symptom-inducing process in plants comprising the induction of phloem sieve occlusion via callose deposition. Flagellin22 (FLG22), a known pathogen-associated molecular pattern, was infiltrated in the leaves of 3-week-old tomato plants (variety Moneymaker tomato).

FIG. 1B shows the tests performed in order to assess the presence of callose in the phloem of the tomato plants.

FIG. 2 shows the particle size distribution and polydispersity index of hydroxypropylmethylcellulose acetate succinate (HPMCAS) nanoparticles loaded with astaxanthin (AXN).

FIG. 3 shows the effect of AXN-loaded nanoparticles following the foliar application on the intraluminal callose formation in the phloem of tomato plants. A) shows the cross-sectional images of the stem from untreated plants using a confocal microscope, and B) shows the cross-sectional images of the stem from plants treated with AXN-loaded nanoparticles using a confocal microscope. These images were captured 24 hours after the infiltration of FLG22. All arrows point to blue callose deposition.

FIG. 4A shows the particle size characterization of nanoparticles loaded with both AXN and fluorophore and stabilized with HPMCAS.

FIG. 4B shows the emission spectra of the dyes used to assess visually the effectiveness of the loaded nanoparticulate formulation in preventing callose formation in tomato plant phloem. These spectra show the fluorescence properties of the dyes and their compatibility with the nanoparticles, enabling accurate visualization and evaluation of their performance in inhibiting callose formation.

FIG. 5 shows the presence of AXN-loaded nanoparticles within the cells of foliarly treated plants. The leaves were treated with nanoparticles comprising AXN (60 uL), with the dye 1,1′-dioctadecyl-3,3,3′,3′-tetramethylindocarbocyanine perchlorate and HPMCAS (0.05 ug/mL). A-D shows cross-sections of 28-day-old tomato plant stems captured under a confocal microscope in figures. Arrows labeled “P” indicate the color pink, which indicates the presence of 1,1′-dioctadecyl-3,3,3′,3′-tetramethylindocarbocyanine perchlorate. Arrows labeled “Y” indicate the color yellow, which indicates the presence of CFW specifically highlights the cell walls in the images. No signal from aniline blue was detected, suggesting the absence of callose deposition produced by AXN, thus confirming that callose deposition is the direct result of FLG22 exposure upon leaf infiltration.

FIG. 6 shows the Flash NanoPrecipitation process for preparing a nanoparticulate formulation.

FIG. 7 shows the workflow for the 24-hour dialysis process applied to nanoparticulate formulation.

FIG. 8 shows the mean particle size for lecithin-astaxanthin (labeled as AXN in graph) and lecithin-polystyrene (labeled as PS in graph) nanoparticle formulations.

FIG. 9 shows the production of kinetic reactive oxygen species (ROS) upon flg22 elicitation. Treatments included 0.1% Silwet-77 in water, Lecithin-PS, and LEC-AXN, with and without flg22 elicitation. Significant differences were determined using a two-way ANOVA followed by Tukey's post hoc test (p<0.05), with letters denoting statistically significant differences among treatments. Error bars are standard errors for n=4 leaf punches.

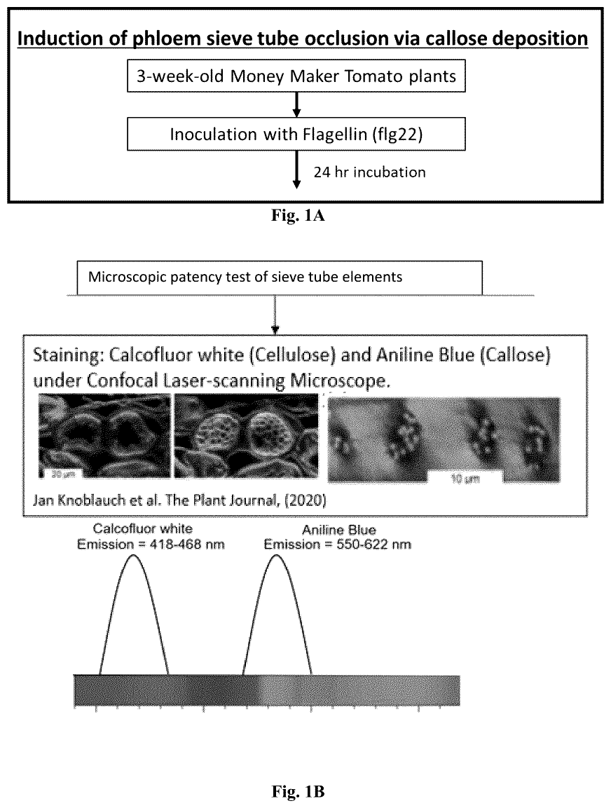

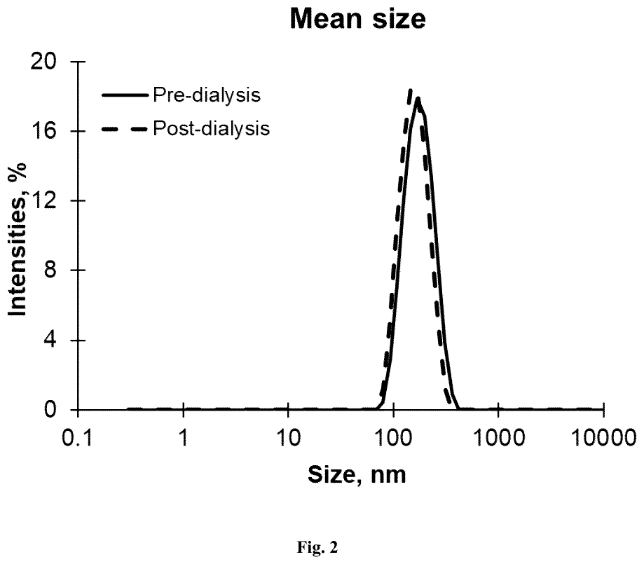

### DETAILED DESCRIPTION

The hypersensitive response (HR) is a defense mechanism employed by plants to recognize and restrict the spread of pathogens. During the HR, the formation of callose deposits is a crucial event. “Callose” refers to a plant polysaccharide produced due to the glucan synthase-like gene (GLS) in various places within a plant. It acts as a temporary cell wall in response to stimuli such as stress or damage. Callose formation can be intraluminal, i.e., in the vasculature of the plant. The term “phloem” refers to plant vascular tissue that transports food made in the leaves during photosynthesis to all other parts of the plant. A good analogy for callose formation is fever in humans, which is a defense response by the body to disease but can sometimes cause more damage to the human than the disease. If callose formation is a permanent fever, there is a need to develop a fever reducer or fever preventative agent for plants.

Thus, provided is a nanoparticulate formulation that can prevent or suppress the HR response in plants and thereby can prevent or treat the formation of callose deposits in plants, including those infected with phloem-restricted pathogens.

The nanoparticulate formulation comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer comprises an amphiphilic molecule, wherein the core is encapsulated in the shell as a nanoparticle.

In some embodiments, the nanoparticulate formulation comprises at least one antioxidant, and at least one imagining agent encapsulated in a stabilizer. In some embodiments, the stabilizer is an amphiphilic stabilizer. The amphiphilic stabilizers can serve as the nanoparticle surface stabilizing layer. In some embodiments, the stabilizer comprises an amphiphilic molecule. In some embodiments, the nanoparticulate formulation further comprises at least one active agent. The active agent can treat phloem or root infections or otherwise manage plant health.

Any suitable antioxidant, as well-known in the art, can be used. An antioxidant reduces and neutralizes the adverse effect of oxidative stress. In some embodiments, the antioxidant is selected from astaxanthin (AXN), alpha-tocopherol, alpha-tocopherol acetate, beta-carotene, lycopene, lutein, zeaxanthin, beta-cryptoxanthin, alpha-carotene, xanthophyll, retinol, retinal, canthaxanthin, violaxanthin, phytoene, phytofluene, neoxanthin, echinenone, resveratrol, pterostilbene, and a combination of two or more thereof. In some embodiments, the antioxidant is AXN. AXN, chemically known as 3,3′-dihydroxy-β-carotene-4,4′-dione, is a xanthophyll carotenoid. AXN can prevent, interrupt, or suppress the oxidative burst and reduce the intensity of the HR.

Any suitable imaging agent can be encapsulated in the core along with AXN to assess the translocation of nanoparticulate formulation following foliar application in plant tissue. This encapsulated imaging agent can enable visual assessment of its location within the plant tissue by microscopy or X-ray fluorescence mapping. One or more imaging agents can be used in combination. The imaging agent used can be a dye, a tracer metal, or any combination thereof. In some embodiments, the dye is selected from 1,1′-dioctadecyl-3,3,3′,3′-tetramethylindocarbocyanine perchlorate, hostasol yellow, hostasol red, perylene, vanadyl 2,9,16,23-tetraphenoxy-29H,31H-phthalocyanine, meso-tetraphenyl-tetrabenzoporphine palladium complex, and a combination of two or more thereof. In some embodiments, the tracer metal is selected from palladium, gadolinium, europium, vanadium, gold, and silver. In some embodiments, the imaging agent is 1,1′-dioctadecyl-3,3,3′,3′-tetramethylindocarbocyanine perchlorate. One advantage of this imaging agent is that its emission spectra do not overlap with those of calcofluor white or aniline blue, which are commonly used dyes for visualization of cell components and callose. This lack of overlap ensures that 1,1′-dioctadecyl-3,3,3′,3′-tetramethylindocarbocyanine perchlorate does not interfere with or cause noise in the visualization of these two dyes. Therefore, it can be used simultaneously with aniline blue and/or calcofluor white.

In some embodiments, the antioxidant can be used in combination with at least one active agent. Any suitable active agent that can treat phloem or root infections or otherwise manage plant health can be used. Examples of active agents include, but are not limited to, streptomycin, oxytetracycline, polymyxin b, colistin, gentamycin, vancomycin, mastoparan 7, tobramycin, kanamycin, amikacin, beta-cyfluthrin, zeta-cypermethrin, chlorantraniliprole, cyantraniliprole, propiconazole, propamocarb, prothioconazole, azoxystrobin, fludioxonil, benzovindiflupyr, boscalid, methoxyfenozide, sarmentine, spliceostatin C, spermine, spermidine, jasmonic acid, farnesene, squalene, diploptene, phytane, cycloartenol, stigmasterol, labdane, phytol, betulinic acid, abietane, cembrene A, cadinene, humulene, zingiberene, longifolene, caryophyllene, farnesol vetivazulene, guaiazulene, germacrene A, germacrene D, linalyl butyrate, copaene, geranyl butyrate, beta-Ocimene, P-cymene, patchoulol, geranyl propionate, viridiflorol, geranyl acetate, estragole, limonene, alpha-terpinyl acetate, thymol, carvacrol, beta-pinene, neral, geraniol, citral, methyl eugenol, alpha-terpinene, linalool, perillic acid, perillaldehyde, methyl cinnamate, eucalyptol, eugenol, acetyleugenol, thujone, 4-carvomenthenol, camphor, guaianolide, cinnamaldehyde, bisacurone, rishitin, cyphenothrin, esfenvalerate, etofenprox, fenpropathrin, fenvalerate, flucythrinate, flumethrin, cyhalothrin, phenothrin, resmethrin, silafluofen, fluvalinate, and permethrin.

Any suitable amphiphilic molecule can be used in the stabilizer. Amphiphilic molecules are chemical compounds that have both polar and nonpolar regions, giving them both hydrophilic (water-loving) and lipophilic (fat-loving) properties. Any suitable amphiphilic molecule, as well-known in the art, can be used to encapsulate at least one antioxidant alone or in further combination with at least one imaging agent, at least one active agent, or a combination thereof. In some embodiments, the amphiphilic molecule is hydroxypropylmethylcellulose acetate succinate (HPMCAS). HPMCAS is an amphiphilic stabilizer. The amphiphilic stabilizers can serve as the nanoparticle surface stabilizing layer.

In some embodiments, the weight fraction of the antioxidant, such as AXN, in the nanoparticulate formulation is about 20-70% by mass. In some embodiments, the ratio of AXN and HPMCAS used is about 20:80, such as 20:80. In some embodiments, the ratio of AXN and HPMCAS is about 30:70, such as 30:70. In some embodiments, the ratio of AXN and HPMCAS is about 50:50, such as 50:50. In some embodiments, the ratio of AXN and HPMCAS is about 70:30, such as 70:30.

In some embodiments, the amphiphilic molecule is selected from lecithin (e.g., soybean lecithin), gelatin, zein, casein, tocopherol polyethylene glycol succinate, sucrose esters, sucrose alkyl ester, lauryl glucoside, decyl glucoside, octyl glucoside, alkyl glucoside, and a combination thereof. In some embodiments, the amphiphilic molecule is sucrose stearate, sucrose distearate, or a combination thereof. In some embodiments, the nanoparticulate formulation further comprises at least one active agent. The active agents can treat phloem or root infections or otherwise manage plant health.

Provided is a method for preparing nanoparticles, which method comprises:
(i) dissolving at least one antioxidant, alone or in further combination with at least one imaging agent, or any combination thereof and a stabilizer in an organic solvent to obtain an organic feed solution;
(ii) mixing the organic feed solution of step (i) rapidly with an aqueous feed solution, wherein the aqueous feed solution optionally comprises a stabilizer, whereupon nanoparticles are formed.

In some embodiments, the method can further comprise the inclusion of at least one active agent in the organic feed solution and optionally in the aqueous feed solution.

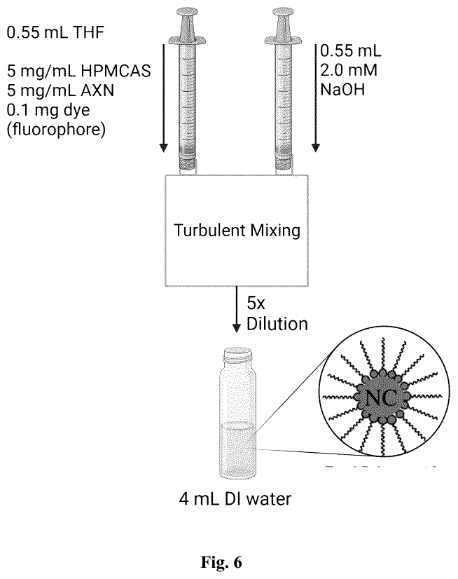

The nanoparticles can be prepared using the Flash NanoPrecipitation process (see FIG. 6) facilitated through a confined impinging jet mixer or multi-inlet vortex mixer. The process allows for precise control over the formulation process, resulting in efficient loading of AXN into the nanoparticulate formulation. The rapid mixing of the two feed solutions can lead to rapid precipitation of the components from the organic solution due to a sudden change in the solvent quality.

In some embodiments, the method further comprises subjecting the formed nanoparticles to a quench bath, which can directly affect the size due to minimizing unimer exchange, and dialysis against water to remove excess solvent, which can eliminate further size change of the nanoparticles.

In some embodiments, the organic solvent that can be used for Flash NanoPrecipitation is a water-miscible organic solvent such as tetrahydrofuran.

The size of the nanoparticle can be about 20 nm to about 300 nm, such as about 20 nm to 300 nm, or 20 nm to about 300 nm, or 20 nm to 300 nm. In some embodiments, the size of the nanoparticle is about 25 nm to about 250 nm. In some embodiments, the size of the nanoparticle is about 50 nm to about 200 nm. In some embodiments, the size of the nanoparticle is about 100 nm to about 200 nm. In some embodiments, the size of the nanoparticle is about 120 nm to about 250 nm. In some embodiments, the size of the nanoparticle is about 150 nm to about 200 nm.

Further provided is a method for preventing or treating callose formation in a plant, which method comprises administering to the plant an effective amount of a nanoparticulate formulation, wherein the nanoparticulate formulation comprises:
(i) a core comprising at least one antioxidant, alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

Antioxidants, imaging agents, active agents, and amphiphilic molecules used are as defined above.

Any suitable block copolymer, as well-known in art, can be used as a stabilizer. The block copolymer comprises at least one hydrophobic block and at least one hydrophilic block. Examples of hydrophobic blocks include, but are not limited to, polycaprolactone, poly(lactic-co-glycolic acid), polystyrene, polylactic acid, and any combination thereof. Examples of hydrophophilic blocks include, but are not limited to, polyethylene glycol, polyacrylic acid, poly[2 (dimethylamino)ethyl methacrylate], and any combination thereof.

Further provided is a method for preventing or suppressing a hypersensitive response in a plant, which method comprises administering to the plant an effective amount of a nanoparticulate formulation, wherein the nanoparticulate formulation comprises:
(i) a core comprising at least one antioxidant, alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

In some embodiments, the nanoparticulate formulation can be administered to the plant through foliar delivery. The nanoparticulate formulation can move from the dosed leaf to other locations, preventing or treating callose formation. Thus, it can reduce callose formation in the plant vasculature away from the delivery location, e.g., a stem and roots. This systemic effect of the nanoparticulate formulation of significantly reducing callose formation in distal parts of the plant (e.g., stem, roots) indicates effective uptake and translocation of the loaded nanoparticulate formulation to the phloem and biological activity at those sites. In some embodiments, the nanoparticulate formulation can be administered through stomata, root hairs, or cracks on the leaf surface.

A variety of plants that have the HR response triggered can be treated with nanoparticulate formulation. In some embodiments, the plant is a tomato plant. The nanoparticulate formulation can prevent or treat HR in plants triggered by the recognition of specific molecules associated with the plant pathogen. Plant pathogens are very similar to those that cause disease in humans and animals. Examples of plant pathogens include, but are not limited to, fungi, fungal-like organisms, oomycetes, bacteria, phytoplasmas, viroids, viruses, insects, and nematodes. In some embodiments, the HR response is triggered due to phloem-restricted pathogen invasion.

The nanoparticulate formulation can also be utilized as a prophylactic therapy where the formulation can be applied proactively to plants before any pathogen invasion occurs, bolstering their immune defenses and reducing the likelihood of infection and subsequent symptom development.

Example of callose formation caused by pathogens includes, but is not limited to, citrus greening disease (bacteria), powdery mildew (fungi), downey mildew (oomycetes), Pseudomonas syringae (bacteria), nematode attacks, and environmental factors such as abiotic stress.

The nanoparticulate formulation can be customized based on the ratio of agents used in the core and shell and particle size. The dosage amount and delivery approach can be optimized based on the nanoparticulate formulation delivered and the plant treated.

The nanoparticulate formulation of the disclosure can be delivered to a plant via aerosol, drop-cast, spray, hydroponics, aeroponics, seed treatment, seedling root dipping, soil application, nutrient for tissue culture, in vitro culture, application with irrigation water, or a combination thereof. The nanoparticulate formulation can be delivered to the soil in which the plant is growing. In some embodiments, the nanoparticulate formulation is delivered to the foliage of the plant. In some embodiments, the nanoparticulate formulation is delivered to the plant via injection.

Further, a nanoparticulate formulation can be used for preventing or treating a disease or a condition that is mediated by HR in a plant. It can modulate the immune response of plants as needed and thereby disrupt the HR that typically occurs during pathogen invasion, effectively preventing the formation of callose deposition. Thus, it can stop plant malnutrition and improve plant health and productivity.

### EXAMPLES

The following examples serve to illustrate the present disclosure. The examples are not intended to limit the scope of the claimed invention in any way.

Phloem-restricted bacterial pathogens present a unique challenge as they cannot be cultured or handled in vitro. When testing the effectiveness of nanoparticulate formulation loaded with antioxidants to prevent callose formation in the phloem, the symptoms caused by these pathogens were replicated. The disease symptoms, specifically the formation of callose deposition within the phloem, were mimicked. The efficacy of the nanoparticulate formulation in preventing or mitigating the callose deposition, providing valuable insights for potential treatments or preventive strategies, was evaluated.

### Preparation of Nanoparticulate Formulation Using Flash NanoPrecipitation

The process was carried out in a confined impinging jets mixer (CIJ) (see FIG. 6). The active ingredient astaxanthin (AXN) (concentration of 5 mg/mL), the stabilizer hydroxypropylmethylcellulose acetate succinate (HPMCAS) (concentration of 5 mg/mL), and a fluorophore (concentration of 0.1 mg/mL) were dissolved in tetrahydrofuran (THF) to obtain the organic stream. Sodium hydroxide (2.0 millimolar) dissolved in deionized water (DI water) to obtain the aqueous solvent stream. The two streams were rapidly introduced, resulting in turbulent and homogeneous mixing within the CIJ's mixing chamber. This rapid mixing led to the rapid precipitation of the components from the organic stream, driven by the sudden change in solvent quality. The sudden change in solvent quality led to particle assembly on the scale of milliseconds (Flash). Post-rapid homogenous mixing, the newly formed nanoparticles (NPs) were subjected to a 4 mL quench bath to minimize unimer exchange which directly affects size. All particle assembly was performed in the mixing chamber of the CIJ. The resulting carriers were kinetically frozen at a size of approximately 150 nm. The 5 mL of NPs were subjected to 24 hour dialysis against dI water to remove any excess organic solvent to eliminate further any size change of NPs.

TABLE 1

| | |
|---|---|
| Organic Stream | Aqueous Stream |

| | | | | |
|---|---|---|---|---|
| Astaxanthin | 5 | mg/mL | 1.6 | mM NaOH |
| HPMCAS | 5 | mg/mL | | |
| DiI | 0.1 | mg/mL | | |
| Volume | 0.55 | mL | 0.55 | mL |

### Application of NPs to Plants

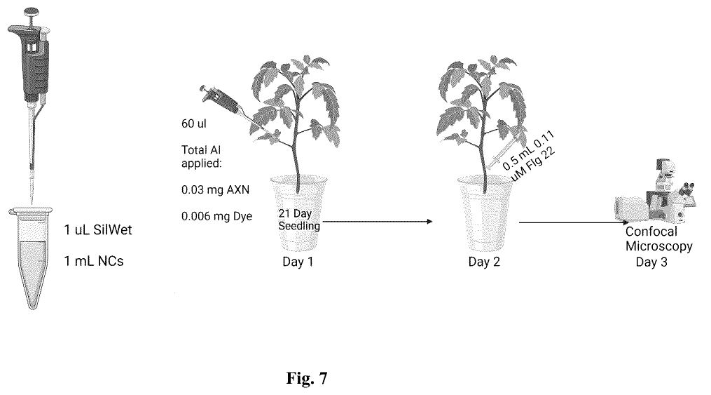

Silwet (1 μl), a commonly used agricultural surfactant, was introduced into a 1.5 mL centrifuge tube. Silwet (0.1% by volume) was incorporated into the NP suspension. The resulting mixture of Silwet and NPs was administered to the second true branch of 28-day-old tomato plant, the MoneyMaker variety, in a 60-microliter volume (FIG. 7). This application resulted in a total mass of 30 micrograms of AXN and 6 micrograms of fluorophore being delivered to a 21-day-old MoneyMaker tomato seedling. Following the NP application, the second true leaf was infiltrated with flagellin 22 (FLG22) on the second true branch of the MoneyMaker Tomato plant. Subsequently, the plant's defense response, including the hypersensitive reaction, was allowed to propagate for an additional 24 hours. After this 24-hour post-infiltration period, the plants were harvested and divided into stems, roots, and branches (at the application site of the nanoparticulate formulation).

### Effect of AXN-Loaded Nanoparticulate Formulation Following Foliar Application

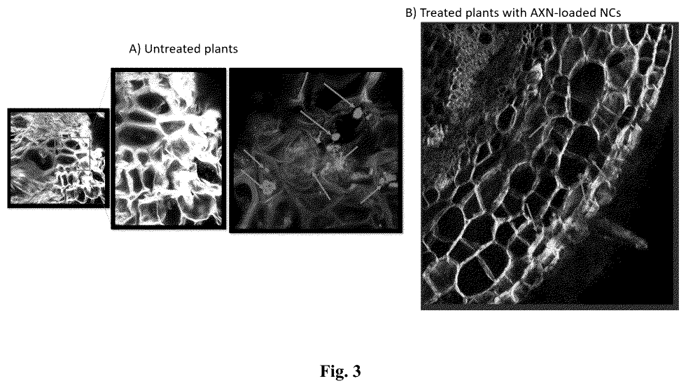

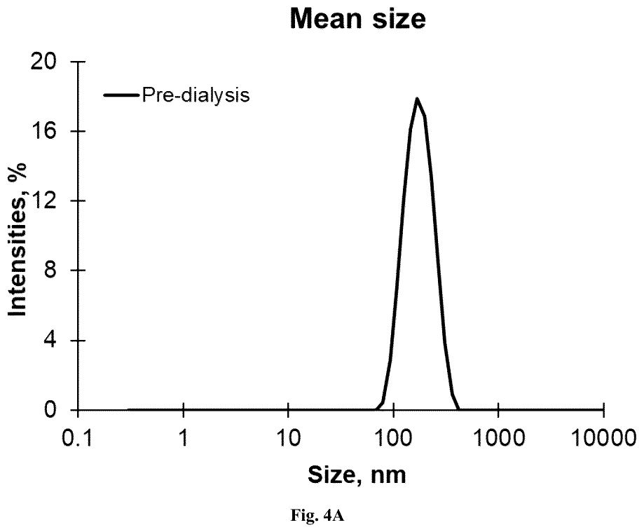

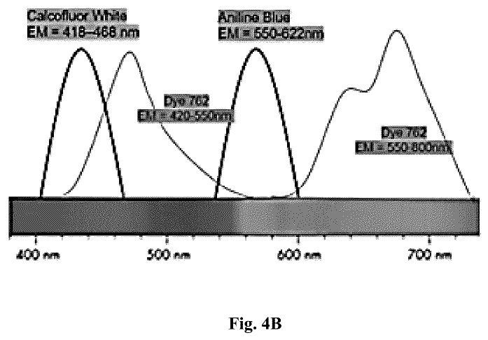

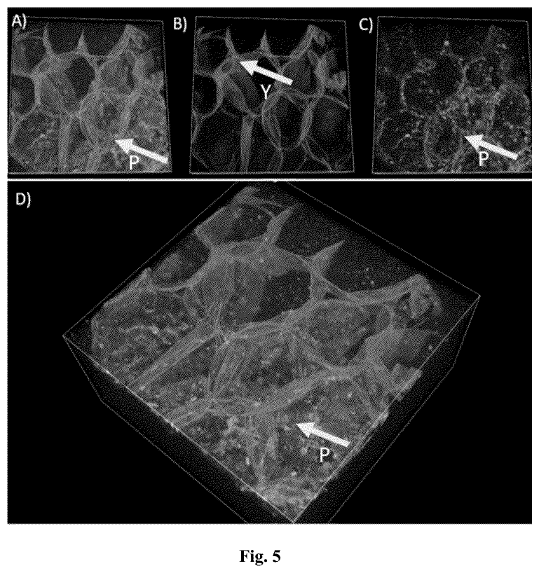

In the group of treated plants, a single branch had its leaves exposed to a dosage of 60 μL of AXN NPs (0.5 ug/mL). In contrast, the control group did not receive any dosage of NPs. After 24 hours post-dosage (hpd), the same leaves from the dosed branch underwent infiltration with a solution of FLG22 (0.1 mM) dissolved in synthetic apoplastic fluid, using a volume of 500 L. Differential visualization of cell walls and callose depositions were performed by simultaneous staining with calcofluor white and aniline blue. To analyze the effects, cross-sectional images of the stem were captured using a confocal microscope (see FIG. 3). All arrows point to blue callose deposition.

The nanoparticulate formulations using stabilizers such as sucrose stearate and sucrose disterate, respectively, were prepared using the process as described herein above.

### Results

The nanoparticulate formulation, specifically the nanoencapsulation of AXN in HPMCAS, effectively prevented the formation of callose in the phloem of tomato plants that were infiltrated with Flagellin22. The confocal microscopy images provided clear evidence of the absence of callose deposition in the treated plants, indicating the successful inhibition of this detrimental response. These indicated that the nanoparticulate formulation effectively mitigated the formation of callose and contributed to improved plant health.

### Particle Size Characterization and Dynamic Light Scattering of NPs

NPs were analyzed to determine particle size distribution, both before and after dialysis (Table 2), and stability. The results showed no significant variation in the particle size distribution post-dialysis, indicating a high level of stability throughout the nanoparticulate formulation formation process. The results showed their uniformity and stability. This suggested that the encapsulated materials, such as AXN, remain well-dispersed within the nanoparticulate formulation and that the structural integrity of the particles was maintained. The achieved stability was of great importance for applications involving nanoparticulate formulation, as it ensures consistent and reliable performance in delivering encapsulated substances.

TABLE 2
Formulation: AXN:1.3

| | Pre-Dialysis | Post-Dialysis |
|---|---|---|
| Mean size ± SD (d · nm) | 162.5 ± 3.69 | 130.7 ± 1.52 |
| PDI ± SD | 0.22 ± 0.00 | 0.25 ± 0.01 |
| Mean ZP ± SD (mV) | −9.71 ± 1.91 | −8.98 ± 1.67 |

The emission spectra of the dyes were used to assess visually the effectiveness of the loaded nanoparticulate formulation in preventing callose formation in tomato plant phloem.

### Presence of AXN in Plant

FIG. 5 shows the presence of AXN-loaded nanoparticulate formulation within the cells of foliarly treated plants. In one branch of a 28-day-old tomato plant, the leaves were treated with nanoparticulate formulation with a dosage of 60 L of AXN nano-encapsulated in HPMCAS at a concentration of 0.05 ug/mL. The images were acquired 24 hours after the dosage. For the stem cross-section samples, a simultaneous staining technique was employed using aniline blue (AB) and calcofluor white (CFW). CFW specifically highlights the cell walls, appearing as yellow (indicated with arrows labeled “Y”) in the images. Pink spots (indicated with arrows labeled “P”) indicate the presence of 1,1′-dioctadecyl-3,3,3′,3′-tetramethylindocarbocyanine perchlorate. No signal from AB was detected, suggesting the absence of callose deposition produced by AXN, thus confirming that callose deposition is the direct result of flagellin22 exposure upon leaf infiltration.

### Nanocarrier Materials

Astaxanthin (AXN; HPLC grade 99.9%) was purchased from Sigma Aldrich (St. Louis, MO, USA). Polystyrene (PS; MW 1.8 KDa) was purchased from PolymerSource (Montreal, Quebec, Canada). L-alpha lecithin, granular, from soybean oil was purchased from Millipore Sigma (St. Louis, MO, USA). 1,1′-diotadecyl-3,3,3′,3′-tetrachmetylindocarbocyanine perchlorate (DiI) was purchased from Millipore Sigma (St. Louis, MO, USA). Tetrahydrofuran (THF; HPLC grade, 99.9%) was purchased from Fisher Scientific (Pittsburgh PA, USA).

Silwet-77 was purchased from Phtotech Labs (St. Lenexa, KS). Moneymaker tomato seeds were a gift from the Iyer-Pascuzzi Lab. Deionized water (ddH₂O) was utilized throughout the experiment for washing and dilution. A 96-well plate Perkin Elmer OptiPlate-96 from Thermofisher (Waltham, MA) served as the primary vessel for sample handling. Leaf punches were prepared using a standard leaf punch tool. Chemiluminescent assay reagents included horseradish peroxidase (Thermo Scientific Waltham, MA) and luminol (FUJIFILM Wako Chemicals Richmond, VA).

### Nanocarrier Preparation and Characterization

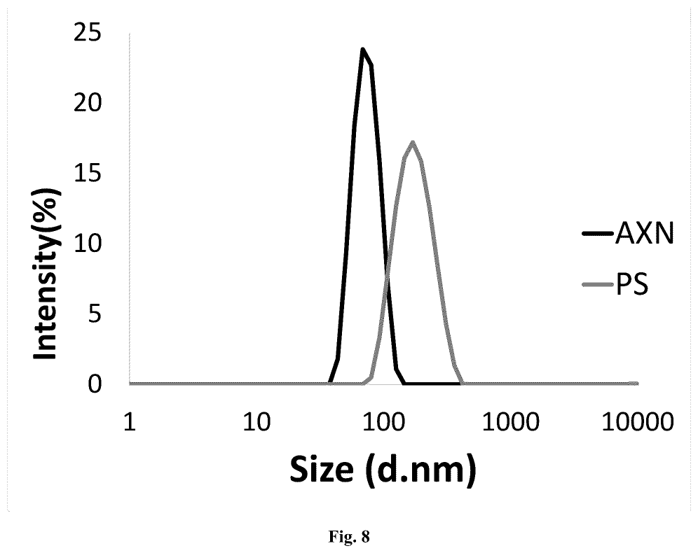

Stock solutions were prepared by dissolving lecithin, PS, and AXN in THE at 15 mg/mL and DiI at 0.3 mg/mL. The mixtures were subjected to sonication for 10 minutes to ensure homogeneous dissolution. Organic feed streams were generated by combining equal volumes of stabilizer(lecithin), AXN or PS stock, and DiI for a final composition of 5 mg/mL lecithin, 5 mg/mL AXN or PS, and 0.1 mg/mL DiI. The resulting organic feed stream (0.5 mL) was rapidly impinged against an antisolvent stream of deionized water (0.5 mL) using a confined impingement jet mixer (CIJ), with the mixture quenched into 4 mL of deionized water. Nanocarrier hydrodynamic size and polydispersity index (PDI) were measured via dynamic light scattering (DLS). Briefly, a 0.1 mL aliquot of nanocarrier suspension was added to 0.9 mL of deionized water to a cuvette for size and polydispersity distribution analysis using dynamic light scattering at a 1730 backscatter (Malvern Zeta Sizer Pro, Malvern Instruments). For zeta potential measurements, nanocarriers were diluted 10-fold in 20 mM NaCl. All measurements were conducted in triplicate. Sample correlograms, size, and zeta potential measurements are provided in FIG. 8. FIG. 8 shows the mean sizes and zeta potentials for each formulation, confirming that the nanocarrier formulations are the intended size for the application. The mean particle size, polydispersity index (PDI), and zeta potential were measured after dialysis and are shown in Table 3.

TABLE 3

| Formulation | Size | PDI | Zeta Potential |
|---|---|---|---|
| AXN | 124.7 ± 6.88 | 0.26 ± 0.06 | −39.34 ± 0.81 |
| PS | 164.4 ± 3.6 | 0.09 ± 0.1 | −41.8 ± 4.5 |

### Nanocarrier Foliar Application

Nanocarrier suspensions (0.1 mL) were applied foliarly using a pipette to the adaxial surface of all leaflets on the second true rachis of 4-week-old Moneymaker tomato plants n=3. This rachis was designated as the exposed leaf. Plants were grown hydroponically in quarter-strength Hoagland's solution. To enhance wettability, the nanocarrier suspension contained 0.1% v/v Silwet-77. The mock treatment consisted of 0.1% Silwet in deionized water.

### Preparation of Reagents and Elicitor Mixes

Stock solutions of horseradish peroxidase (500×HPSS) and luminol (500×LSS) were prepared by dissolving 10 mg of horseradish peroxidase in 1 mL ddH₂O and 6.2 mg L-012 in 1 mL dimethyl sulfoxide (DMSO), respectively. Both solutions were aliquoted into 1.5 mL tubes and stored at −20° C. Freshly prepared elicitor mixes were used for the chemiluminescent assay. The mock treatment consisted of ddH₂O with 500×LSS, and HPSS added before use. Flagellin 22 (Flg22), by diluting their respective stock solutions in ddH₂O to final concentrations of 1 μM, respectively, with the addition of LSS and HPSS before application.

### Reactive Oxygen Species (ROS) Assay

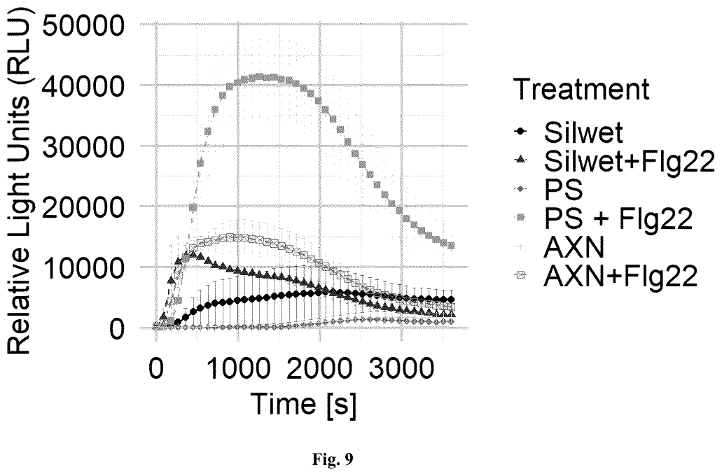

On Day 1, tomato plants were treated with the respective formulation. On Day 2, tomato leaf disks were prepared from the exposed leaf using a leaf punch tool. Six leaf punches were taken from each treated exposed leaf for 18 disks for each treatment and placed in water. Four discs from each treatment were randomly selected and placed into a well of a 96-well plate pre-filled with 200 μL of deionized water. After all samples were distributed, the disks were washed by replacing the deionized water every 30 minutes for four washes using a multichannel pipette. The plate was then covered with aluminum foil and stored in a dark drawer overnight. On Day 3, the plate reader (Spectra Max I3x) was turned on and warmed to 24° C. for 20 minutes. During this time, the elicitor mixes were prepared. Water was removed from the 96-well plate, and treatments were applied to the wells using a multichannel pipette. LSS and HPSS were added to the premixed solutions for each treatment, swirled to mix, and distributed into wells as quickly as possible to minimize variability. The plate was immediately loaded into the reader, and the ROS assay program was initiated. The program ran for 31 kinetic cycles with a 2-minute interval between cycles, an integration time of 1500 ms, and automatic luminescence attenuation. A Sample ROS curve is provided in FIG. 9.

The hypersensitive response (HR) involves the generation of reactive oxygen as part of the oxidative burst. When the oxidative burst is prevented or suppressed, it reduces the intensity of an HR response and subsequent callose deposition. In the flg22 elicitation, chemiluminescence is generated as a readout of reactive oxygen species (ROS) production triggered by the plant's immune response. Flg22, a conserved peptide fragment of bacterial flagellin, acts as a microbe-associated molecular pattern (MAMP) recognized by the plant's pattern recognition receptors (PRRs). Upon recognition, flg22 activates a signaling cascade that rapidly induces the production of ROS as part of the plant's defense response. These ROS react with luminol in the presence of horseradish peroxidase (HRP), leading to luminol oxidation. This reaction results in chemiluminescence, which is proportional to the ROS levels and is a quantitative measure of the plant's immune activation. Lecithin-AXN formulations significantly decreased chemiluminescence compared to lecithin-PS formulations, indicating ROS scavenging capabilities either through ROS diffusion into the nanocarriers or, more likely, the upregulation of ROS-scavenging enzymes such as superoxide dismutase, catalase, and peroxidase.

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. The terms “including” and “having” are defined as comprising (i.e., open language).

It will be appreciated by persons skilled in the art that the present disclosure is not limited by what has been particularly shown and described herein above. Rather the scope of the present disclosure includes both combinations and sub-combinations of the various features described hereinabove as well as variations and modifications which would occur to persons skilled in the art upon reading the specification and which are not in the prior art.

Patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference.

What is claimed is:

1. A method of preventing or treating a callose formation in a plant, which method comprises administering to the plant an effective amount of a nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

2. The method of claim 1, wherein the nanoparticulate formulation is administered through foliar, root, trunk, or seed delivery.

3. The method of claim 1, wherein:
(i) the antioxidant is selected from astaxanthin, alpha-tocopherol, alpha-tocopherol acetate, beta carotene, lycopene, lutein, zeaxanthin, beta-cryptoxanthin, alpha-carotene, xanthophyll, retinol, retinal, canthaxanthin, violaxanthin, phytoene, phytofluene, neoxanthin, echinenone, resveratrol, pterostilbene, and a combination of two or more thereof;
(ii) the imaging agent is selected from 1,1′-dioctadecyl-3,3,3′,3′-tetramethylindocarbocyanine perchlorate, hostasol yellow, hostasol red, perylene, vanadyl 2,9,16,23-tetraphenoxy-29H,31H-phthalocyanine, meso-tetraphenyl-tetrabenzoporphine palladium complex, a tracer metal and any combination thereof;
(iii) the active agent is selected from streptomycin, oxytetracycline, polymyxin b, colistin, gentamycin, vancomycin, mastoparan 7, tobramycin, kanamycin, amikacin, beta-cyfluthrin, zeta-cypermethrin, chlorantraniliprole, cyantraniliprole, propiconazole, propamocarb, prothioconazole, azoxystrobin, fludioxonil, benzovindiflupyr, boscalid, methoxyfenozide, sarmentine, spliceostatin C, spermine, spermidine, jasmonic acid, farnesene, squalene, diploptene, phytane, cycloartenol, stigmasterol, labdane, phytol, betulinic acid, abietane, cembrene A, cadinene, humulene, zingiberene, longifolene, caryophyllene, farnesol vetivazulene, guaiazulene, germacrene A, germacrene D, linalyl butyrate, copaene, geranyl butyrate, beta-Ocimene, P-cymene, patchoulol, geranyl propionate, viridiflorol, geranyl acetate, estragole, limonene, alpha-terpinyl acetate, thymol, carvacrol, beta-Pinene, neral, geraniol, citral, methyl eugenol, alpha-terpinene, linalool, perillic acid, perillaldehyde, methyl cinnamate, eucalyptol, eugenol, acetyleugenol, thujone, 4-carvomenthenol, camphor, guaianolide, cinnamaldehyde, bisacurone, rishitin, cyphenothrin, esfenvalerate, etofenprox, fenpropathrin, fenvalerate, flucythrinate, flumethrin, cyhalothrin, phenothrin, resmethrin, silafluofen, fluvalinate, and permethrin;
(iv) the amphiphilic molecule (a) is hydroxypropylmethylcellulose acetate succinate or (b) is selected from lecithin (e.g., soybean lecithin), gelatin, zein, casein, tocopherol polyethylene glycol succinate, a sucrose ester, a sucrose alkyl ester, lauryl glucoside, decyl glucoside, octyl glucoside, an alkyl glucoside, and any combination thereof, and/or
(v) the block copolymer comprises (a) at least one hydrophobic block selected from polycaprolactone, poly(lactic-co-glycolic acid), polystyrene, and polylactic acid; (b) at least one hydrophophilic block selected from polyethylene glycol, polyacrylic acid, and poly[2 (dimethylamino)ethyl methacrylate]; or (c) a combination of (a) and (b).

4. The method of claim 3, wherein the tracer metal is selected from palladium, gadolinium, europium, vanadium, gold, and silver.

5. The method of claim 3, wherein the amphiphilic molecule is a sucrose alkyl ester.

6. The method of claim 5, wherein the sucrose alkyl ester is sucrose stearate or sucrose distearate.

7. A method of preventing or suppressing a hypersensitive response in a plant, which method comprises administering to the plant an effective amount of a nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer is selected from an amphiphilic molecule, at least one block copolymer, and any combination thereof, wherein the core is encapsulated in the shell as a nanoparticle.

8. The method of claim 7, wherein the nanoparticulate formulation is administered through foliar, root, trunk, or seed delivery.

9. The method of claim 7, wherein:
(i) the antioxidant is selected from astaxanthin, alpha-tocopherol, alpha-tocopherol acetate, beta carotene, lycopene, lutein, zeaxanthin, beta-cryptoxanthin, alpha-carotene, xanthophyll, retinol, retinal, canthaxanthin, violaxanthin, phytoene, phytofluene, neoxanthin, echinenone, resveratrol, pterostilbene, and a combination of two or more thereof;
(ii) the imaging agent is selected from 1,1′-dioctadecyl-3,3,3′,3′-tetramethylindocarbocyanine perchlorate, hostasol yellow, hostasol red, perylene, vanadyl 2,9,16,23-tetraphenoxy-29H,31H-phthalocyanine, meso-tetraphenyl-tetrabenzoporphine palladium complex, a tracer metal and any combination thereof;
(iii) the active agent is selected from streptomycin, oxytetracycline, polymyxin b, colistin, gentamycin, vancomycin, mastoparan 7, tobramycin, kanamycin, amikacin, beta-cyfluthrin, zeta-cypermethrin, chlorantraniliprole, cyantraniliprole, propiconazole, propamocarb, prothioconazole, azoxystrobin, fludioxonil, benzovindiflupyr, boscalid, methoxyfenozide, sarmentine, spliceostatin C, spermine, spermidine, jasmonic acid, farnesene, squalene, diploptene, phytane, cycloartenol, stigmasterol, labdane, phytol, betulinic acid, abietane, cembrene A, cadinene, humulene, zingiberene, longifolene, caryophyllene, farnesol vetivazulene, guaiazulene, germacrene A, germacrene D, linalyl butyrate, copaene, geranyl butyrate, beta-Ocimene, P-cymene, patchoulol, geranyl propionate, viridiflorol, geranyl acetate, estragole, limonene, alpha-terpinyl acetate, thymol, carvacrol, beta-Pinene, neral, geraniol, citral, methyl eugenol, alpha-terpinene, linalool, perillic acid, perillaldehyde, methyl cinnamate, eucalyptol, eugenol, acetyleugenol, thujone, 4-carvomenthenol, camphor, guaianolide, cinnamaldehyde, bisacurone, rishitin, cyphenothrin, esfenvalerate, etofenprox, fenpropathrin, fenvalerate, flucythrinate, flumethrin, cyhalothrin, phenothrin, resmethrin, silafluofen, fluvalinate, and permethrin;
(iv) the amphiphilic molecule (a) is hydroxypropylmethylcellulose acetate succinate or (b) is selected from lecithin (e.g., soybean lecithin), gelatin, zein, casein, tocopherol polyethylene glycol succinate, a sucrose ester, a sucrose alkyl ester, lauryl glucoside, decyl glucoside, octyl glucoside, an alkyl glucoside, and any combination thereof, and/or
(v) the block copoymer comprises (a) at least one hydrophobic block selected from polycaprolactone, poly(lactic-co-glycolic acid), polystyrene, and polylactic acid; (b) at least one hydrophophilic block selected from polyethylene glycol, polyacrylic acid, and poly[2 (dimethylamino)ethyl methacrylate]; or (c) a combination of (a) and (b).

10. The method of claim 9, wherein the tracer metal is selected from palladium, gadolinium, europium, vanadium, gold, and silver.

11. The method of claim 9, wherein the amphiphilic molecule is a sucrose alkyl ester.

12. The method of claim 11, wherein the sucrose alkyl ester is sucrose stearate or sucrose distearate.

13. A nanoparticulate formulation, which comprises:
(i) a core comprising at least one antioxidant alone or in further combination with (a) at least one imaging agent, (b) at least one active agent, or (c) a combination of (a) and (b); and
(ii) a shell comprising a stabilizer, wherein the stabilizer comprises an amphiphilic molecule, wherein the core is encapsulated in the shell as a nanoparticle.

14. The nanoparticulate formulation of claim 13, wherein:
(i) the antioxidant is selected from astaxanthin, alpha-tocopherol, alpha-tocopherol acetate, beta carotene, lycopene, lutein, zeaxanthin, beta-cryptoxanthin, alpha-carotene, xanthophyll, retinol, retinal, canthaxanthin, violaxanthin, phytoene, phytofluene, neoxanthin, echinenone, resveratrol, pterostilbene, and a combination of two or more thereof;
(ii) the imaging agent is selected from 1,1′-dioctadecyl-3,3,3′,3′-tetramethylindocarbocyanine perchlorate, hostasol yellow, hostasol red, perylene, vanadyl 2,9,16,23-tetraphenoxy-29H,31H-phthalocyanine, meso-tetraphenyl-tetrabenzoporphine palladium complex, a tracer metal and any combination thereof;
(iii) the active agent is selected from streptomycin, oxytetracycline, polymyxin b, colistin, gentamycin, vancomycin, mastoparan 7, tobramycin, kanamycin, amikacin, beta-cyfluthrin, zeta-cypermethrin, chlorantraniliprole, cyantraniliprole, propiconazole, propamocarb, prothioconazole, azoxystrobin, fludioxonil, benzovindiflupyr, boscalid, methoxyfenozide, sarmentine, spliceostatin C, spermine, spermidine, jasmonic acid, farnesene, squalene, diploptene, phytane, cycloartenol, stigmasterol, labdane, phytol, betulinic acid, abietane, cembrene A, cadinene, humulene, zingiberene, longifolene, caryophyllene, farnesol vetivazulene, guaiazulene, germacrene A, germacrene D, linalyl butyrate, copaene, geranyl butyrate, beta-Ocimene, P-cymene, patchoulol, geranyl propionate, viridiflorol, geranyl acetate, estragole, limonene, alpha-terpinyl acetate, thymol, carvacrol, beta-Pinene, neral, geraniol, citral, methyl eugenol, alpha-terpinene, linalool, perillic acid, perillaldehyde, methyl cinnamate, eucalyptol, eugenol, acetyleugenol, thujone, 4-carvomenthenol, camphor, guaianolide, cinnamaldehyde, bisacurone, rishitin, cyphenothrin, esfenvalerate, etofenprox, fenpropathrin, fenvalerate, flucythrinate, flumethrin, cyhalothrin, phenothrin, resmethrin, silafluofen, fluvalinate, and permethrin; and/or
(iv) the amphiphilic molecule (a) is hydroxypropylmethylcellulose acetate succinate or (b) is selected from lecithin (e.g., soybean lecithin), gelatin, zein, casein, tocopherol polyethylene glycol succinate, a sucrose ester, sucrose alkyl ester, lauryl glucoside, decyl glucoside, octyl glucoside, alkyl glucoside, and a combination of two or more thereof.

15. The nanoparticulate formulation of claim 14, wherein the tracer metal is selected from palladium, gadolinium, europium, vanadium, gold, and silver.

16. The nanoparticulate formulation of claim 15, wherein the amphiphilic molecule is a sucrose alkyl ester.

17. The nanoparticulate formulation of claim 16, wherein the sucrose alkyl ester is sucrose stearate or sucrose distearate.

18. The nanoparticulate formulation of claim 13, wherein the nanoparticle is about 20 nm to about 300 nm in diameter.

19. The nanoparticulate formulation of claim 14, wherein the nanoparticle is about 20 nm to about 300 nm in diameter.
